(19) United States
(12) Patent Application Publication
(10) Pub. No.: US 2004/0132494 A1
(43) Pub. Date: Jul. 8, 2004

(54) Communication method

(76) Inventors: Olav Tirkkonen, Helsinki (FI); Markku Kuusela, Helsinki (FI); Yrjo Kaipainen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/336,037

(22) Filed: Jan. 3, 2003

(51) Int. Cl. H04M 1/00; H04B 1/04

(52) U.S. Cl. 455/562.1; 455/101; 455/103; 455/129

(57) ABSTRACT

This invention relates to a method for use in a communication system comprising at least one transmitter and at least one receiver, said at least one transmitter comprising a plurality of transmitting antennas, said method comprising the steps of transmitting from at least one but not all of said transmitting antennas a reference signal on a respective first channel; transmitting data from said transmitting antennas on respective second channels, wherein the second channels transmitted by said at least one but not all transmitting antennas are supported by the respective first channel and the second channels transmitted by the other of said transmitting antennas are supported by a reference signal provided in the respective second channel.

### FIELD OF THE INVENTION

The present invention relates to a method for providing a reference for use in determining a channel characteristic. In particular, but not exclusively, the reference may be a pilot signal. The present invention also relates to a communication system for providing a reference for use in determining a channel characteristic.

### BACKGROUND OF THE INVENTION

Wireless cellular communication networks and the modes of operation are generally well known. In such a system, the area covered by the network is divided into cells. Each cell is provided with a base station, which is arranged to communicate with a plurality of mobile stations or other user equipment in the cell associated with the base station

In these known systems, a channel is typically allocated to each user. For example, in the case of the GSM (Global System for Mobile Communications) standard, a user is allocated a given frequency band in a particular time slot in that frequency band. A single information stream from a single user can be allocated a frequency band and time slot. The so called third generation standards currently being proposed used code division multiple access (CDMA). In this standard, a user is allocated a particular spreading code to define a channel.

In the third generation wide band CDMA system (3GPP WCDMA), there are different versions of the standard. One version, the first version is the release 1999 version (rel 99). Developments are continually being made to that standard and the current version of that standard is referred to as release 5 (rel 5).

In the 3GPP WCDMA system, there are two primary common pilot channels (P-CPiCH). Reference is made to FIG. 1 which illustrates schematically this arrangement. There are two transmit antennas 2 and 4. It should be appreciated that each of these transmit antennas may in fact be provided by a single antenna or an array of antennas. In this document, the term transmit antenna is intended to cover an arrangement where the antenna is a single antenna or an array of antenna. The transmit antenna will effectively provide a beam. Each of the transmit antennas 2 and 4 are arranged to transmit a pilot sequence. The pilot sequences transmitted by the two transmit antennas are orthogonal. A user 6 is arranged to receive the pilot sequences from both of the transmit antennas two and four and from that is able to provide a first channel estimate h1 for the signals transmitted by the first transmit antenna 2 and a second channel estimate h2 for the signals transmitted by the second transmit antenna 4.

The common pilot channel measurements are used for soft hand over measurements, idle mode cell selection and synchronisation in at least some of the versions of the third generation standards.

Whilst this system works well where there are two transmit antennas, if the number of transmit antennas is increased, the inventors have realised that the arrangement of the pilot channels becomes difficult. For example, in the case where there are four transmit antennas, it is clear that dividing the common channel power by four is not a viable solution. The release 99 terminals would find that the measurements for soft handover, idle mode cell selection and synchronisation would be compromised if the primary common pilot channel power were to be diminished. One solution to this problem would be to double the common pilot channel power by adding secondary common pilot channels with the same power as the primary common pilot channel. However, this would be wasteful of power and is undesirable in a system which is particularly sensitive to overall power levels.

As the pilot channel and estimation properties of different transmit antennas are different this situation is referred to as asymmetric channel estimation.

One solution has been proposed in PCT/FI02/00350. In this document, a system is provided which has at most two primary common pilot channels transmitted and at least one secondary common pilot channel. The ratio of the primary to secondary pilot power and the total pilot power are adjustable. There is also a dedicated pilot signal which has an adjustable power. The ratio of the dedicated pilot power transmitted with the beams used for transmitting the secondary common pilot signals to the dedicated pilot power used for transmitting the primary pilot signals is inversely proportional to the ratio of the secondary and primary pilot channels. In other words, the concept described by this document is to offset or increase the dedicated pilot power transmitted from those antennas which are supported by a week secondary pilot. In this document, the dedicated pilots to all four antennas are transmitted from a common pilot channel slot with at least four symbols, by using orthogonal Hadamard sequences.

However, this arrangement has the disadvantage that the power offset on the dedicated physical channel DPCCH has to be large if the secondary common pilot channel power is low. This causes excessive fluctuating interferences to other users. In the alternative, long dedicated physical channel sequences have to be designed, which is of ineffective from a communication point of view. The longer the power control sequences, the less data can be transmitted.

It is believed that when the wide band CDMA systems are first introduced, the majority of terminals or at least a sizeable number will be rel 99 terminals with only a few users using non rel 99 terminals i.e. terminals in compliance with later versions of the standard. In one solution, the pilot power of users interested in using arrangements with the four transmitting antennas could be pooled. However, if there are low number of sporadically active low mobility users, the advantageous effect of pooling the pilot power to a secondary common pilot pool are not likely to be realised. Due to the low mobility, channels do not need to be continuously estimated. Also due to the sporadic packet data transmissions, it is likely that dedicating a fraction of power for continuous secondary control pilot channels would be wasteful.

### SUMMARY OF THE INVENTION

It is an aim of embodiments of the present invention to address one or more of the problems discussed above.

According to a first aspect of the present invention there is provided a method for use in a communication system comprising at least one transmitter and at least one receiver, said at least one transmitter comprising a plurality of transmitting antennas, said method comprising the steps of transmitting from at least one but not all of said transmitting antennas a reference signal on a respective first channel; transmitting data from said transmitting antennas on respective second channels, wherein the second channels transmitted by said at least one but not all transmitting antennas are supported by the respective first channel and the second channels transmitted by the other of said transmitting antennas are supported by a reference signal provided in the respective second channel.

According to a second aspect of the present invention there is provided a communication system comprising at least one transmitter and at least one receiver, said at least one transmitter comprising a plurality of transmitting antennas, said transmitting antennas arranged to transmit from at least one but not all of said transmitting antennas a reference signal on a respective first channel and to transmit data on respective second channels, wherein the second channels transmitted by said at least one but not all transmitting antennas are supported by the respective first channel and the second channels transmitted by the other of said transmitting antennas are supported by a reference signal provided in the respective second channel. According to a third aspect of the present invention there is provided a transmitter comprising a plurality of transmitting antennas, said transmitting antennas arranged to transmit from at least one but not all of said transmitting antennas a reference signal on a respective first channel and to transmit data on respective second channels, wherein the second channels transmitted by said at least one but not all transmitting antennas are supported by the respective first channel and the second channels transmitted by the other of said transmitting antennas are supported by a reference signal provided in the respective second channel.

### BRIEF DESCRIPTION OF DRAWINGS

For a better understanding of the present invention and as to how the same it may be carried into effect, reference will now be made by way of example to the accompanying of drawings in which:

FIG. 1 shows a transmitter with two transmitting antennas;

FIG. 2 shows a transmitter with four transmitting antennas embodying the present invention;

FIG. 3 shows the data channels transmitted by the antennas of FIG. 2; and

FIG. 4 shows a telecommunications system in which embodiments of the present invention can be used.

### DETAILED DESCRIPTION OF PREFERRED EMBODIMENTS OF THE PRESENT INVENTION

Reference to made to FIG. 4, which shows part of a cellular telecommunications network in which embodiments of the present invention can be implemented. The area covered by the network is divided into a plurality of cells 32, only three of which are shown. In practice, there will be larger number of cells. It should be appreciated that in some embodiments of the present invention, the cells may overlap at least partially or totally.

Each cell is associated with a base transceiver station 34. The base transceiver station 34 is arranged to communicate with mobile terminals or other user equipment 36 located in the cell associated with a base station. It should be appreciated that in some embodiments of the present invention, the base stations may communication with mobile stations 36 outside the associated cell.

It in preferred embodiments of the present invention, the transmitter antennas are located at one base station site. Again, it should be emphasized that in embodiments of the present invention, the term transmitter antenna is intended to cover both where the transmitter is a single antenna or an array of antennas. However, each antenna will transmit different channels to a given user.

Embodiments of the present invention will be described in relation to a system where four transmit antennas are used. It should be appreciated that embodiments of the present invention can be used in any system where there are two or more transmit antennas. Any number of transmit antennas can be provided but preferred embodiments of the present invention will have an even number of transmitters.

The user equipment 36 can take any suitable form and may for example be a mobile device such as a mobile telephone, mobile terminal, portable computer, laptop computer, personal digital assistant, or the like. In some embodiments of the present invention, the user equipment may in fact be a fixed wireless device.

In the preferred embodiments of the present invention described herein, the user equipment 36 is described as having a single antenna. However, it should be appreciated that alternative embodiments of the present invention can be used with arrangements where the user equipment 36 has more than one receiving antenna. It should be appreciated that again, in the context of this document, the term “receiving antenna” is intended to cover either a single antenna or an array of antennas. One example of a system where both the transmitter and the receiver have multiple antennas is a multiple input multiple output (MIMO) system. In a MIMO system, information is transmitted generally in parallel by the multiple antennas and is received generally in parallel by the receiving antennas.

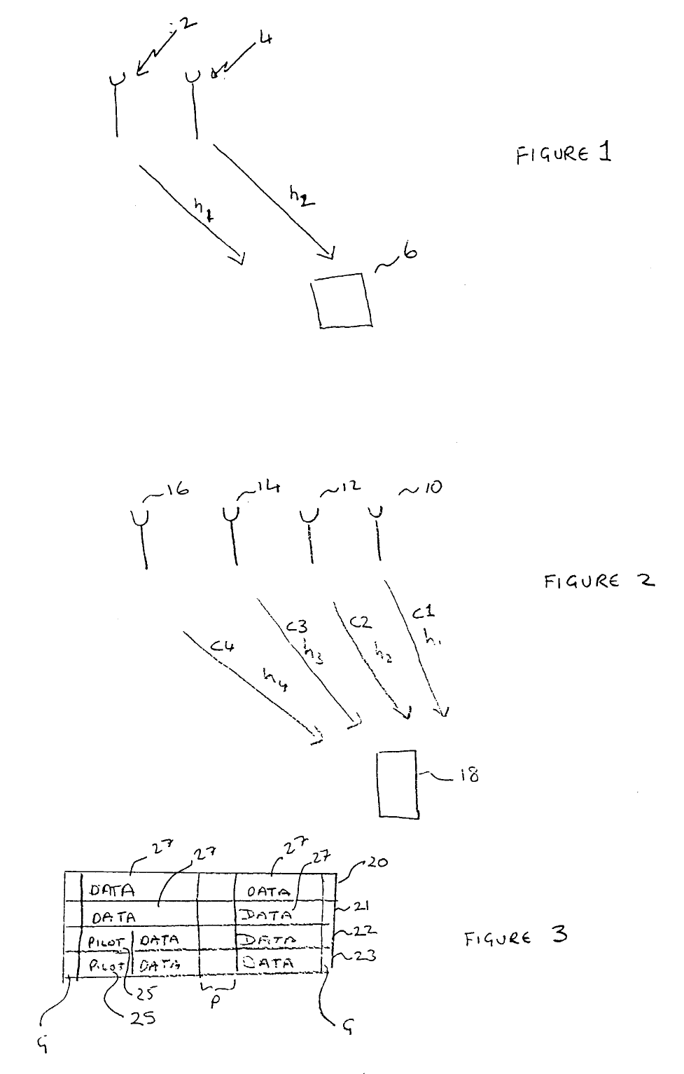

Reference is now made to FIG. 2 which shows an embodiment of the present invention. In this embodiment, the transmitter comprises four transmitting antennas 10, 12, 14 and 16. Each of these transmitting antennas is arranged to transmit a different channel to user equipment 18 To explain embodiments of the present invention, it will be assumed that the first antenna 10 transmits in a first channel C1, the first channel C1 having a channel characteristic h1. Likewise, the second transmitting antenna 12 transmits on a second channel C2 having a channel characteristic h2. The third antenna 14 transmits on a third channel C3 having a channel characteristic h3. Finally, the fourth transmitting antenna 16 transmits on a fourth channel C4 having a channel characteristic h4. It should be appreciated that in practice, each transmitting antenna may transmit more than one channel at the same time to the same and/or different users.

In the preferred embodiments of the present invention, the first transmitting antenna 10 and the second transmitting antenna 12 are arranged to transmit primary common pilot channels. The primary common pilot channels transmitted by the first and second antennas 10 and 12 use the same spreading code but the pilot symbols transmitted by the primary common pilot channels are orthogonal to one another. The third and fourth transmitting antennas 14 and 16 are each arranged to provide a secondary common pilot channel. The secondary common pilot channels use the same spreading code, which is different from that used by the primary common pilot channels. However, the symbols transmitted by the third and fourth transmitting antennas 14 and 16 are orthogonal to each other. It should be appreciated that the total pilot power, i.e. the total power used to transmit the four pilot channels, that is the two primary pilot channels and the two secondary pilot channels, is divided such that most of the power is used by the first and second primary common pilot channels. Accordingly, the secondary common pilot channels will have relatively low power. In some embodiments of the present invention, the secondary common pilot channel may in fact not be in transmitted.

The pilot symbols are symbols which the transmitter transmits and which are known to the receiver. The receiver knows what symbols it should receive and effectively carries out a analysis on the received symbols with respect to the expected symbols. Based on this analysis, a channel estimate, for example, a channel impulse response, can be determined. This channel estimate effectively provides information about the characteristic of the channel and the distortion provided by the channel to the transmitted symbols. Using information about the channel means that the receiver is better able to make an estimate as to what the received symbols should be.

In addition to the common pilot channels, one or more and preferable all of the transmitting antennas 10-16 is arranged to transmit an Dedicated Physical Channel (DPCH) channel. This channel effectively allows data to be transmitted from the transmitting antennas 10 to 16 to be user 18. In WCDMA, the dedicated physical channel is characterized by a channelization code, which is user specific, and separates each users's DPCH from common channels. Detecting DPCH relies on information obtained from the pilot symbols. In particular, channel estimates based on the pilot symbols are used to help the receiver determine the actual data that has been transmitted by the transmitting antennas.

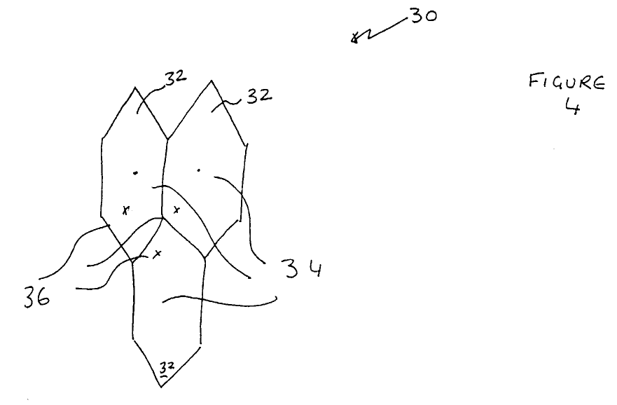

Reference is made to FIG. 3 which schematically illustrates four DPCH channels 20-23. The first channel 20 is transmitted by the first transmitting antenna 10, the second channel 21 by the second transmitting antenna 12 with the third and fourth channels 22 and 23 being transmitted by the third and fourth transmitting antennas 14 and 16 respectively. The first and second DPCH channels 20 and 21 are transmitted by antennas 10 and 12 and are thus supported by the primary common pilot channels. Since the primary common pilot channels are transmitted with a relatively high power, a good estimate of the channel between the first and second transmitters and the receiver is available. Accordingly the DPCH channels 20 and 21 transmitted by the first and second transmitting antennas 10 and 12 contain data 27. It should be appreciated that all of the channels transmitted by each of the antennas have a guard period G at the beginning of each time slot and a guard period at the end of each time slot. Each of the DPCH channels also includes a number of pilot symbols P. The number depends of the slot format, and if transmission from four antennas is considered, a slot format with at least four pilot symbols P is preferable. These pilot symbols are used for example SIR (signal to interference ratio) estimation of that channel, and for verification of feedback transmissions. It should be appreciated that the actual format of each slot is usually governed by the relevant standard. Thus, the slot format shown in FIG. 3 is by way of example only. In WCDMA, the part of DPCH used for data transmission is called the Dedicated Physical Data Channel (DPDCH). Correspondingly, the part used for control information, for example the pilot bits, is called Dedicated Physical Control Channel (DPCCH).

In embodiments of the present invention, the DPDCH channels transmitted by the third and fourth transmitting antennas 14 and 16 are arranged so that instead of transmitting just data, at least part of the DPDCH field available for data transmission is used to transmit pilot symbols 25. The pilot symbols 25 are preferably transmitted at the beginning of the field available for data. This is so that the pilot symbol information can be used to provide a channel estimate which can be used for the data in the same time slot.

In the arrangement shown in FIG. 3, the pilot symbols 25 are shown as being provided together at the beginning of a first data field. It should be appreciated that in alternative embodiments of the present invention the pilot symbols may be interleaved with the data through some or all the data field or fields provided. It is also possible in alternative embodiments of the present invention to divide the pilot symbols between the number of available data fields. The pilot symbols can of course in alternative embodiments of the present invention follow the data.

In preferred embodiments of the present invention, the extra pilot symbols are not provided in every time slot. The pilot symbols may be provided in every N time slots where N is an integer. N can be fixed or N can be varied in dependence on the channel conditions. If, for example, the channel conditions are stable, then N may be large. If the channel conditions are unstable the N will be smaller. Typically, the channel conditions would be unstable if the user is moving, with increasing changes in the channel with increasing speed. Various techniques are known in the art for estimating the change in channel characteristics, for example, by estimating the Doppler shift. Accordingly, in some embodiments of the present invention, one of these techniques is used to estimate a rate of change ot the channel characteristics and based on this information, the value of N can be selected appropriately.

An example of an embodiment of the present invention will now be described. In this model, it is assumed that there are four channels being transmitted by four transmitting antennas. For the purpose of this model, the channels are assumed to be uncorrelated and Rayleigh fading. Two channels (the one supported by the primary common pilot channels) are used for STTD (space time transmit diversity) encoding whilst pilot bits are transmitted on two channels. In other words, data is transmitted by two channels with pilot symbols being transmitted by two channels. The transmitted signal Cᵢ can be represented by the following matrix:

$${C}_{i} = [ \begin{matrix}{z}_{2 i - 1} & {z}_{2 i} & p & p \\ {z}_{2 i}^{*} & {z}_{2 i - 1}^{*} & p & - p\end{matrix} ] \qquad ( 1 )$$

The first row of the matrix represents time T1 and the second row of the matrix represents time T2. The first column of the matrix represents the symbols transmitted by the first transmit antenna, the second column the symbols is transmitted by the second antenna, with the third and fourth columns representing the symbols that are transmitted by the third and fourth antennas respectively. As can be seen, the first and second transmit antennas transmit data symbols Z whilst the third and fourth transmit antennas transmit pilot symbols p. The symbol p is a pilot bit. The pilot symbols transmitted by the third and fourth transmit antennas are orthogonal. In one tap channels, \overline{α}=[α₁,α₂,α₃,α₄]^{T}, where αₙ is the channel characteristic of the channel of the nth transmitter. The received signal r during two symbol periods is as follows:

$$[ \begin{matrix}{r}_{2 i - 1} \\ {r}_{2 i}\end{matrix} ] = C {α}^{->} + noise = [ \begin{matrix}{α}_{1} {z}_{2 i - 1} + {α}_{2} & {z}_{2 i} + p ( {α}_{3} + {α}_{4} ) \\ {α}_{2} {z}_{2 i - 1}^{*} - {α}_{1} & {z}_{2 i}^{*} + p ( {α}_{3} + {α}_{4} )\end{matrix} ] \qquad ( 2 )$$

In this model it is assumed that the environment is a low mobility. It is also assumed that the channels are consistent during a predetermined time period T of channel estimation. That is, the transmission scheme is continued during T symbol periods so that T symbols are transmitted together with the co-channel pilots. T is even. Also, in the model, it is assumed that no other pilot power is available of estimating channels 3 and 4 (from the third and fourth transmitters), that is that the secondary pilot channels are effectively zero. In practice, they may well be a secondary pilot channel and that can be used in assisting to determine the channel characteristic.

The co-channel estimation works as follows:

$$\begin{matrix}Tp {\hat{α}}_{3} = {\sum }_{i = 1}^{T} {r}_{i} ≡ Tp {α}_{3} + {\sum }_{i = 1}^{T / 2} ( {α}_{2} ( {z}_{2 i - 1} - {z}_{2 i}^{*} ) + {α}_{2} ( {z}_{2 i} + {z}_{2 i - 1}^{*} ) ) + noise & ( 3 ) \\ Tp {\hat{α}}_{4} = {\sum }_{i = 1}^{T / 2} {r}_{2 i - 1} - {r}_{2 i} & \\ ≡ Tp {α}_{4} + {\sum }_{i = 1}^{T / 2} ( {α}_{1} ( {z}_{2 i - 1} + {z}_{2 i}^{*} ) + {α}_{2} ( {z}_{2 i} - {z}_{2 i - 1}^{*} ) ) + noise & \end{matrix}$$

It should be appreciated that the ratio of the second term to the first term of the equations tend to zero. In any event α₁ and α₂ are known from the primarly pilot channels and the symbols transmitted on these channels can be estimated. The values of p are known so that there are two unknowns α₃ and α₄ and two equations so the value of the two unknowns can be determined.

Thus, the STTD encoded symbols add to the channel estimation noise. When T increases, this additional noise becomes randomised. Due to the well known properties of random walks, the additional noise grows as a square root of T, whereas a term related to the channels to be estimated grow linearly with T. Thus, the extra channel estimation noise due to co-channel STTD decreases as the square root of T. This property becomes important in determining the optimal values of T and p in normal channel estimation, only additive noise and co-channel interferences are fought against. Thus, it is optimal to have a large p and a small T. It should be appreciated that embodiments of the present invention, a different criteria may be desirable.

As a first stage the STTD bits are decoded as follows:

$$\begin{matrix}[ \begin{matrix}{α}_{1} & {α}_{2} \\ {α}_{2}^{*} & {α}_{1}^{*}\end{matrix} ] [ \begin{matrix}{r}_{2 i - 1} \\ {r}_{2 i}^{*}\end{matrix} ] = ( {\vert {α}_{1} \vert}^{2} + {\vert {α}_{2} \vert}^{2} ) [ \begin{matrix}{z}_{2 i - 1} \\ {z}_{2 i}\end{matrix} ] + \\ p [ \begin{matrix}( {α}_{3} + {α}_{4} ) {α}_{1}^{*} + ( {α}_{3}^{*} - {α}_{4}^{*} ) {α}_{2} \\ ( {α}_{3} + {α}_{4} ) {α}_{2}^{*} - ( {α}_{3}^{*} - {α}_{4}^{*} ) {α}_{1}\end{matrix} ] + noise\end{matrix} \qquad ( 4 )$$

In other words, the data symbols are estimated from the channel estimate obtained from the pilot symbols of the primary common pilot channel. The pilot symbols transmitted by the third and fourth antennas contribute to the noise.

In this model, T received complex numbers are operated with and it is simultaneously estimated T+2 complex numbers. of these, T are in a finite field, (typically QPSK) and only two, the channels to be estimated are true complex numbers. Thus, with increasing number of measurements, the effective noise can be mitigated and the T+2 numbers may be estimated. STTD estimation per se does not utilize the finite field property. To make use of it, one uses interference cancellations method. Here, hard decisions are used for the symbols. Due to the 1/\sqrt{T} attenuation of the interference caused by the symbols on the channel estimates, the interference cancellation should start with the co-channel estimation of equation 3.

The channel estimates \hat{α}₃,\hat{α}₄ are multiplied by α₁,α₁*,α₂,α₂*. They are subtracted from the matched filter result shown in equation 4 and hard decisions are made for the symbols Z. The sum of these symbol estimates are calculated and the corresponding interference in equation 3 is cancelled leaving to improved channel estimates.

In other words, channels 3 and 4 are first estimated. These estimates are used in the equation 4 to determine the value of the symbols transmitted on channels 1 and 2. The estimated values of the symbols in channels 1 and 2 are then fed back in to equation 3 to give an improved estimate for the channel characteristic of channels 3 and 4Different models can be used which have different numbers of iterations which can improve the result. Iteration is not necessarily used in all embodiments of the invention.

It should be appreciated that the complexity of one such iteration includes two complex multiplications arising from the multiplications in equation 4 and a number of additions. The use of equation 3 to provide better estimates can be formulated so that no additional multiplications arise.

It should be appreciated that the ratio of the pilot symbol power to data power can be varied in accordance with the parameters of the system. The number of estimation periods used can also be varied. As far as the STTD encoded bits are concerned, the main factor appears to be the channel estimation period. Generally, the longer the T, the more interference can be cancelled and the better the bit error rate. However, the actual pilot power does have an impact. For example, as the power increases, it is better that T is less. In one embodiment of the present invention, T may be between 10 and 40 and preferably be between 10 and 20 inclusive. This is for a scheme where there is no other pilot power available for the transmissions from antennas 3 and 4. The more external pilot power available for channels 3 and 4 the shorter T may used. There is a trade off which needs to be considered. The performance penalty on the STTD bit does not depend on the total power. It depends only on the length of the pilot sequence, the longer the sequence the more reliable the STTD bits. This is because an over determined linear system is being dealt with, where T quantized symbols and two complex channels are estimated from T measured complex numbers. Quantisation fights against noise and estimating the channels diminishes this ability. Thus the more STTD symbols the channel estimation is spread amongst, the smaller the performance penalty. However, for channel estimation the opposite is true. With a given total pilot power, at low bit energy per bit to noise ratios, channel estimation works better the shorter the sequence where energy per bit to noise ratio is measured from the STTD channels and the total pilot power is measured as multiples of bit energy. This is a consequence of the fact that spreading the pilot power in time, more disturbing noise power is accumulated. With high bit energy to noise ratios, the code channel STTD interference becomes a dominate factor in channel estimation and it becomes more beneficial to spread the pilot power in time.

Typically T=10-20 and p is approximately the same as the symbol power used on the DPDCH.

Embodiments of the present invention have been described in the context of a 3GPP CDMA system, and for a specific transmit diversity mode; STTD. It should be appreciated that other embodiments of the invention may be used with other CDMA systems. Alternative embodiments of the present invention may be implemented in non CDMA systems. Embodiments may use any transmit diversity/MIMO transmission method with or without feedback. Thus for example antennas 1 and 2 may be arranged to transmit according to WCDMA Feedback Mode 1 or 2, while antennas 3 and 4 transmit co-channel pilot signals.

Embodiments of the present invention have been described in the context of pilot signals. It should be appreciated that other embodiments of the present invention may be used with other reference signals. In the preferred embodiment of the present invention, the pilot signals have been described as providing cnannei estimation information. It should be appreciated that embodiments of the invention can be used where the pilot or reference signal is provided for other purposes.

1. A method for use in a communication system comprising at least one transmitter and at least one receiver, said at least one transmitter comprising a plurality of transmitting antennas, said method comprising the steps of:
transmitting from at least one but not all of said transmitting antennas a reference signal on a respective first channel;
transmitting data from said transmitting antennas on respective second channels, wherein the second channels transmitted by said at least one but not all transmitting antennas are supported by the respective first channel and the second channels transmitted by the other of said transmitting antennas are supported by a reference signal provided in the respective second channel.

2. A method as claimed in claim 1, wherein the reference signal is used to estimate a channel between a respective one of said transmitting antennas and the receiver.

3. A method as claimed in any preceding claim, wherein said transmitting antennas transmit CDMA signals.

4. A method as claimed in any preceding claim, wherein said reference signal comprises pilot symbols.

5. A method as claimed in any preceding claim, wherein said first channel is a common channel.

6. A method as claimed in claim 5, wherein said first channel is a common pilot channel.

7. A method as claimed in claim 6, wherein said first channel is a primary common pilot channel.

8. A method as claimed in any preceding claim, wherein said second channel is a dedicated data channel.

9. A method as claimed in any preceding claim, wherein said second channel comprises time slots.

10. A method as claimed in claim 9, wherein said reference signals are transmitted in the second channel in one or more of the following ways:
every time slot; every N time slots where N is an integer: interleaved within a time slot; and at a predetermined one or more positions in said time slot.

11. A method as claimed in claim 10, wherein the value of N is dependent on the rate of change of said channel.

12. A method as claimed in any preceding claim wherein said second channels are transmitted at the same time.

13. A method as claimed in claim 13, wherein said for at least one time period, data is transmitted by each of the transmitting antennas and for at least one time period, the reference signals are transmitted the other transmitting antennas and data is transmitted by the at least one but not all transmitting antennas.

14. A method as claimed in any preceding claim, wherein said transmitter has at least three transmitting antennas.

15. A method as claimed in any preceding claim, wherein said transmitter has an even number of transmitting antennas.

16. A method as claimed in any preceding claim, wherein said transmitter has 2ⁿ transmitting antennas, where n is an integer greater than or equal to one.

17. A method as claimed in any preceding claim, wherein the at least one but not all transmitting antennas comprises two transmitting antennas.

18. A method as claimed in any preceding claim, wherein the other transmitting antennas are additionally supported by a reference signal on a respective third channel.

19. A method as claimed in claim 18, wherein the third channel is secondary common channel.

20. A method as claimed in claim 18 or 19, wherein the power of the respective first channel is greater than that of the respective third channel.

21. A method as claimed in any preceding claim, wherein said communication system comprises a wireless communication system.

22. A method as claimed in any preceding claim, wherein at least one transmitter comprises at least one of base stations and user equipment.

23. A method as claimed in any preceding claim, wherein at least one receiver comprises at least one of base stations and user equipment.

24. A method as claimed in any preceding claim, wherein at least one receiver comprises a plurality of receiving antennas.

25. A method as claimed in any preceding claims, wherein at least one of said transmitting antennas comprises a plurality of antennas forming an array.

26. A communication system comprising at least one transmitter and at least one receiver, said at least one transmitter comprising a plurality of transmitting antennas, said transmitting antennas arranged to transmit from at least one but not all of said transmitting antennas a reference signal on a respective first channel and to transmit data on respective second channels, wherein the second channels transmitted by said at least one but not all transmitting antennas are supported by the respective first channel and the second channels transmitted by the other of said transmitting antennas are supported by a reference signal provided in the respective second channel.

27. A transmitter comprising a plurality of transmitting antennas, said transmitting antennas arranged to transmit from at least one but not all of said transmitting antennas a reference signal on a respective first channel and to transmit data on respective second channels, wherein the second channels transmitted by said at least one but not all transmitting antennas are supported by the respective first channel and the second channels transmitted by the other of said transmitting antennas are supported by a reference signal provided in the respective second channel.
